(19) United States
(12) Patent Application Publication
(10) Pub. No.: US 2017/0005973 A1
(43) Pub. Date: Jan. 5, 2017

(54) MESSAGE REFRESH FOR COMMUNICATION DEVICES

(71) Applicant: International Business Machines Corporation, Armonk, NY (US)

(72) Inventor: David L. Kaminsky, Chapel Hill, NC (US)

(21) Appl. No.: 14/755,649

(22) Filed: Jun. 30, 2015

(51) Int. Cl. H04L 12/58

(52) U.S. Cl. CPC H04L 51/22; H04L 51/24

(57) ABSTRACT

Managing messages may include sending, using a processor of a messaging system, a first copy of a message to a recipient device, detecting, using the processor, a refresh event requesting a refresh operation for the message, and responsive to the refresh event, sending, using the processor, a second copy of the message to the recipient device without creating a further copy of the message within the messaging system.

### BACKGROUND

The present invention relates to messaging and, more particularly, to message refresh for memory constrained communication devices. Over time, new electronic mail (email) is continually received. The newly received emails cause older emails to migrate down the list of received emails in one's email system. It is often the case that a particular email of interest may not even be in the viewable portion of the list of messages shown on the user's display. Whether accessing email from a Web interface or a more conventional email client, users must often engage in a time consuming process of sifting through emails in order to locate a received email of interest.

In the case of mobile devices, the situation is often worse. Mobile devices are typically configured to delete old emails entirely. For example, a mobile device may be configured to delete emails that are at least N days old. The value of N is often set to a small value, e.g., 3. Keeping the value of N small helps to reduce bandwidth for email synchronization purposes, preserve battery life of the mobile device, and reduce the amount of memory needed for storing email, and/or the like in an already memory limited computing environment. This means that searching for an email of interest more than N days old on a mobile device is often futile.

### SUMMARY

In one embodiment, a method may include sending, using a processor in a messaging system, a first copy of a message to a recipient device and detecting, using the processor, a refresh event requesting a refresh operation for the message. The method may include, responsive to the refresh event, sending, using the processor, a second copy of the message to the recipient device without creating a further copy of the message within the messaging system.

In another embodiment, a messaging system may include a processor programmed to initiate executable operations. The executable operations may include sending a first copy of a message to a recipient device, detecting a refresh event requesting a refresh operation for the message, and responsive to the refresh event, sending a second copy of the message to the recipient device without creating a further copy of the message within the messaging system.

Another embodiment includes a computer program product having a computer readable storage medium having program code stored thereon. The program code is executable by a processor to perform a method. The method may include sending, using the processor, a first copy of a message to a recipient device and detecting, using the processor, a refresh event requesting a refresh operation for the message. The method may also include, responsive to the refresh event, sending, using the processor, a second copy of the message to the recipient device without creating a further copy of the message within the messaging system.

### BRIEF DESCRIPTION OF THE DRAWINGS

FIG. 1 is a block diagram illustrating an exemplary network communication system that may be used to implement one or more embodiments described within this disclosure.

FIG. 2 is a block diagram illustrating an exemplary architecture for a data processing system.

FIG. 3 is a simplified message flow diagram illustrating an exemplary method of message refresh.

FIG. 4 is a flow chart illustrating another exemplary method of message refresh.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to messaging and, more particularly, to message refresh for communication devices. In accordance with the inventive arrangements described within this disclosure, a sending device may send a message to a recipient. At some point after the initial sending of the message, the sender may wish to refresh the previously sent message for one or more of the original recipients. The original message, for example, may include information and/or attachments relating to a scheduled event to which the recipients are invited. As the event draws near, the sender and/or a messaging system may initiate a refresh of the message to one or more or all of the original recipients.

In one aspect, the sender may initiate the refresh by sending a refresh message. The refresh message is different from the originally sent message. The refresh message may specify, or identify, the originally sent message. The messaging system, responsive to receiving the refresh message may locate the message specified by the refresh message stored therein and, in response to the refresh message, send a copy of the previously sent message to one or more selected communication devices of the recipient(s). The receiving communication device(s) may display the newly received copy of message in the list of message according to the date and time of the resent copy of the message as opposed to the date and time of the originally sent message. As such, the newly received copy will be presented at or near the top of a list of received messages.

In another aspect, the messaging system may send the refresh message to one or more other communication devices of the recipient(s). Receipt of the refresh message may cause the receiving communication device to place the originally sent message, still stored locally within the receiving communication device(s), at or near a top of a message list of the receiving communication device. For example, when sorted according to date and time, the originally sent message may be placed in the list at a location determined according to the date and time of the refresh message as opposed to the date and time of the originally received message.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

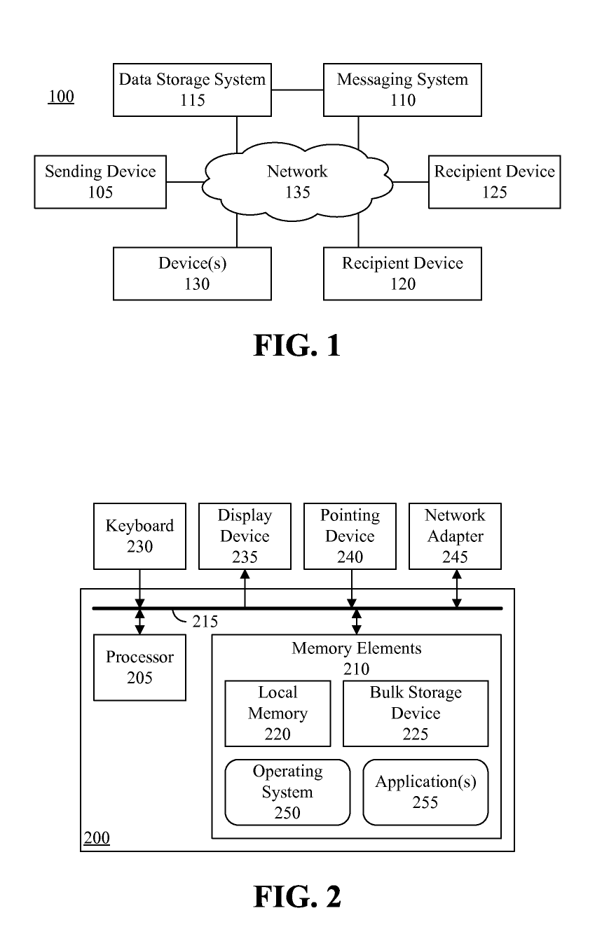

FIG. 1 is a block diagram illustrating an exemplary network communication system 100. One or more embodiments described within this disclosure may be implemented using network communication system 100 or another communication system similar thereto. Network communication system 100 may include a sending device 105, a messaging system 110, an optional data storage system 115, one or more recipient devices such as recipient device 120 and recipient device 125, one or more additional and optional devices 130, and a network 135.

Network communication system 100 may be configured to exchange messages between sending device 105 and recipient device 120 and recipient device 125. It should be appreciated that other devices, e.g., devices 130, also may exchange messages with one or more or all of sending device 105, recipient device 120, recipient device 125, and one or more other ones of devices 130.

The term “message,” as used herein, may refer to an electronic mail (email) message, an instant message (IM), a text message (e.g., a Short Message Service (SMS) message), or the like. The term “message” also may include electronic correspondence such as postings sent using a social networking system.

Sending device 105 may be a communication device. Exemplary communication devices may include, but are not limited to, a personal computer, whether a tablet computer, a desktop computer, a laptop or other portable computer, a mobile phone, or the like. In one aspect, sending device 105 may operate as a client device. For example, sending device 105 may execute client software that, when executed, allows sending device 105 to exchange messages with one or more of the other devices shown using network 135 and messaging system 110.

Messaging system 110 may be implemented as a data processing system. For example, messaging system 110 may be implemented as a server executing suitable operational software and/or server messaging system software. For example, messaging system may be implemented as an email server, an IM server, a text message server, or the like. In another example, messaging system 110 may be implemented as part of a social networking system. Messaging system 110 may receive messages from communication devices, e.g., sending device 105 or any of the various devices illustrated in FIG. 1, and send the received messages to one or more other devices illustrated in FIG. 1.

Data storage system 115 may be an optional portion of network communication system 100. Data storage system 115 may be implemented as a data storage node, e.g., a network adapted storage device (NAS) and/or server. For example, in one aspect, data storage system 115 may be used by messaging system 110. Data storage system 115 may be coupled to messaging system 110 through network 135 and/or using a direct link as pictured.

Recipient device 120 and recipient device 125, while being separate physical devices, each may be associated with a same user. For example, each of recipient device 120 and recipient device 125 may be implemented as a communication device and execute client software allowing each to exchange messages with other ones of the devices shown. In one example, recipient device 120 may be a personal computer while recipient device 125 may be an enumerated type of communication device such as a mobile device. For example, recipient device 125 may be a smart phone executing a messaging application such as an email application, an IM application, a text messaging (SMS) application, and/or the like.

For purposes of illustration, consider the case where recipient device 125 is a memory constrained communication device. Recipient device 120 may maintain or store copies of received messages in a manner that is only limited by the amount of long term memory of recipient device 120. Recipient device 120 may include sufficient long term memory to store the entire set of messages in a particular user account. Recipient device 125 may store only a subset of the entire set of messages that may be stored on recipient device 120. Recipient device 125 may apply a threshold technique for determining which messages are deleted from the device.

In aspect, recipient device 125 may utilize an age threshold where messages determined to be older than the age threshold are deleted from recipient device 125. The age threshold may be set within recipient device 125 by a user, set by a system administrator in recipient device 125, and/or set by a system administrator in messaging system 110. For example, the age threshold may be N days, where N is an integer value that is typically 1, 2, 3, 4, 5, or the like. The way in which the age threshold is specified and/or particular values of the age threshold described herein are provided for purposes of illustration only and, as such, are not intended as limitations of the embodiments described herein. Other age thresholds may be specified as a period of hours, minutes, etc.

In another example, the threshold may be an aggregate size threshold. The aggregate size threshold may be applied to the total number of messages stored in recipient device 125. When the aggregate size of the messages stored in recipient device 125 exceeds the aggregate size threshold, e.g., 50 megabytes, 100 megabytes, 1 gigabyte, etc., the recipient device 125 may delete the oldest message. Recipient device 125 may continue deleting messages from the oldest message to the newest message until the aggregate size of the messages stored therein is at or below the aggregate size threshold.

Devices 130 represent any of a variety of different communication devices, e.g., computers, mobile phones, etc., that may be coupled to other devices through network 135 and/or messaging system 110. Devices 130 may exchange messages with any one or more of the devices illustrated in FIG. 1.

Network 135 is the medium used to provide communication links between the communication devices and systems described with reference to FIG. 1. Network 135 may include connections, such as wired communication links, whether electrical or optical, and wireless communication links. Network 135 may be implemented as, or include, any of a variety of different communication technologies such as a Wide Area Network (WAN), a Local Area Network (LAN), a wireless network whether a wireless WAN or a wireless LAN, a mobile network, a Virtual Private Network (VPN), the Internet, the Public Switched Telephone Network (PSTN), or the like.

In operation, sending device 105 may send a message to the user associated with recipient device 120 and recipient device 125. In sending the message, sending device 105 may send the message to messaging system 110. Messaging system 110, as part of the sending process, sends the message, or a copy thereof, to recipient device 120 and recipient device 125. In this example, recipient device 120 may store a copy of the received message. While a copy of the received message may also be stored in recipient device 125, after the message reaches an age exceeding the age threshold, recipient device 125 may delete the message. The copy of the received message also may be deleted responsive to the aggregate size of messages stored in recipient device 125 exceeding the aggregate size threshold.

Subsequently, sending device 105 may send a refresh message to one or more or all of the recipients of the prior sent message. The refresh message may specify the previously sent message. Messaging system 110 may receive the refresh message. The receipt of the refresh message by messaging system 110 from sending device 105 may be considered the detection of a refresh event. Responsive to the refresh event, messaging system 110 may initiate a refresh operation. The refresh operation may include sending a refresh message and/or sending another copy of the message to the recipient devices. In one aspect, messaging system 110 may send the refresh message to recipient device 120 while sending another copy of the prior sent, i.e., original, message to recipient device 125.

In another embodiment, messaging system 110 may be programmed to automatically initiate a refresh operation. As an example, the originally sent message may relate to a meeting scheduled some time period, e.g., a week, after the original email is sent. Messaging system 110 may be programmed to initiate a refresh operation on the original message at a predetermined amount of time prior to the scheduled meeting. For example, one hour prior to the scheduled meeting, messaging system 110 may detect a refresh event. The refresh event may be the expiration of a timer, the detection of a particular time, the detection of a particular time in relation to a scheduled event, e.g., detecting a predetermined time prior to a scheduled event relating to or associated with the original message, or the like. Responsive to the refresh event, messaging system 110 may initiate a refresh operation. The refresh operation may include sending a refresh message and/or sending another copy of the original message as previously described.

In one example, the original message may be an invitation for the meeting. The original message may include a selected option or computer readable program instruction directing messaging server 110 to start a timer, trigger and/or schedule a refresh event at a particular time, etc. For instance, the original message may include an instruction for messaging system 110 to initiate a refresh operation 1 day later, 2 days later, 1 week later, etc. In another example, the original message may include an instruction for messaging system 110 to initiate a refresh operation at a particular date and/or time. As noted, the original message may include an instruction for message system 110 to initiate the refresh operation at a predetermined amount of time prior to another related and/or scheduled event.

FIG. 1 is intended as an example and not as an architectural limitation of the illustrative embodiments described herein. It should be appreciated that network communication system 100 may include one or more additional or systems and/or devices than shown. In another example, messaging system 110 may be representative of a cloud computing infrastructure.

As used herein, the term “cloud computing” may refer to a computing model that facilitates convenient, on-demand network access to a shared pool of configurable computing resources such as networks, servers, storage, applications, and/or services. These computing resources may be rapidly provisioned and released with minimal management effort or service provider interaction. Cloud computing promotes availability and may be characterized by on-demand self-service, broad network access, resource pooling, rapid elasticity, and measured service. Cloud computing generally supports service models such as Cloud Software as a Service (SaaS), Cloud Platform as a Service (PaaS), and/or Cloud Infrastructure as a Service (IaaS). Cloud computing further may support deployment models such as Private cloud, Community cloud, Public cloud, and/or Hybrid cloud. Further information relating to cloud computing may be obtained from the National Institute of Standards and Technology (NIST) and, more particularly, the Information Technology Laboratory of NIST.

FIG. 2 is an exemplary architecture 200 for a data processing system. Architecture 200 may be used to implement systems and/or devices that include a processor and memory and that are capable of performing the operations described within this disclosure. Architecture 200 may be used to implement any of a variety of different devices including one or more of the communication devices and/or system described herein. For example, referring to FIG. 1, architecture 200, or a variant of architecture 200, may be used to implement sending device 105, messaging system 110, recipient device 120, recipient device 125, and/or one or more of devices 130. In some cases, the particular device or system implemented using architecture 200 may include fewer components or more components than illustrated in FIG. 2. Further, the particular operating system and/or application(s) included may vary.

As pictured, architecture 200 includes at least one processor, e.g., a central processing unit (CPU), 205 coupled to memory elements 210 through a system bus 215 or other suitable circuitry. Architecture 200 stores computer readable program instructions (also referred to as “program code”) within memory elements 210. Memory elements 210 may be considered an example of computer readable storage media. Processor 205 executes the program code accessed from memory elements 210 via system bus 215. In one aspect, memory elements 210 include one or more physical memory devices such as, for example, a local memory 220 and one or more bulk storage devices 225. Local memory 220 refers to random access memory (RAM) or other non-persistent memory device(s) generally used during actual execution of the program code. Bulk storage device 225 may be implemented as a hard disk drive (HDD), solid state drive (SSD), or other persistent data storage device. Architecture 200 may also include one or more cache memories (not shown) that provide temporary storage of at least some program code in order to reduce the number of times program code must be retrieved from bulk storage device 225 during execution.

Input/output (I/O) devices such as a keyboard 230, a display device 235, and a pointing device 240 may optionally be coupled to architecture 200. In some cases, one or more of the I/O devices may be combined as in the case where a touchscreen is used as display device 235. In that case, display device 235 may also implement keyboard 230 and/or pointing device 240.

The I/O devices may include one or more network adapters 245 that may be coupled to architecture 200 to enable architecture 200 to become coupled to other systems, computer systems, remote printers, and/or remote storage devices through intervening private or public networks and/or through direct connections (e.g., peer-to-peer connections). Modems, cable modems, Ethernet cards, and wireless transceivers (e.g., wireless radios) are examples of different types of network adapter 245 that may be used with architecture 200. Depending upon the particular device implemented with architecture 200, the specific type of network adapter, or network adapters as the case may be, will vary.

As pictured in FIG. 2, memory elements 210 store an operating system 250 and one or more applications 255. In one aspect, operating system 250 and application 255, being implemented in the form of program code, are executed by architecture 200. For example, processor 205 may execute operating system 250 and/or application 255. As such, operating system 250 and application 255 may be considered an integrated part of architecture 200. Operating system 250, application 255, and any data items used, generated, and/or operated upon by architecture 200 are functional data structures that impart functionality when employed as part of a system or device implemented using architecture 200. For example, a device and/or system implemented using architecture 200 or a combination of such devices and/or systems may be programmed to initiate executable operations as described within this disclosure.

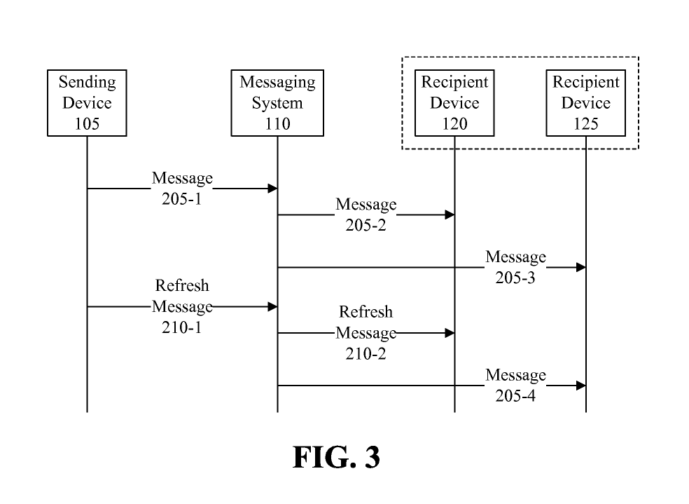

FIG. 3 is a simplified message flow diagram illustrating an exemplary method of message refresh. FIG. 3 illustrates communications between sending device 105, messaging system 110, recipient device 120, and recipient device 125 in accordance with another embodiment described herein. Recipient device 120 and recipient device 125 are bounded by a dashed lined box signifying that both devices may be associated with, e.g., used by, a same user for purposes of exchanging messages.

For purposes of discussion, messages are shown using reference numbers formatted as 205-1, 205-2, etc. It should be appreciated that as a message is sent from one system or device to another, a copy of the message is generated and sent. The reference numbers are intended to aid in differentiating these different copies or versions of a same message that are created as the message travels from a sending device to one or more recipient devices by way of a messaging system. In this regard, message 205-1, 205-2, 205-3, and 205-4, for example, each may refer to the same message 205, but to a different copy of message 205 that may result from processing, forwarding, resending, or other executable operations described within this disclosure.

Thus, FIG. 3 illustrates that message 205 is delivered to each of recipient device 120 and recipient device 125 by messaging system 110 sending a copy of message 205 to each respective device. Messaging system 110 may store a copy of message 205 therein. The copy of message 205 stored within messaging system 110 may be considered the master copy of message 205. Further, message 205 may be intended for one or more other recipients and corresponding recipient devices that are not illustrated in FIG. 3 for purposes of clarity and ease of explanation.

As pictured, sending device 105 may send message 205-1 to one or more intended recipients. A recipient of message 205-1 may be a user of recipient device 120 and recipient device 125. As pictured, sending device 105 sends message 205-1 to messaging system 110. Messaging system 110 identifies the intended recipients of message 205-1 and delivers, or sends, message 205 to the devices of the intended recipient(s). In this example, messaging system 110 sends message 205-2 to recipient device 120 and message 205-3 to recipient device 125. Messaging system 110 may send message 205 to recipient device 120 and recipient device 125 using a push message delivery technique, a pull message delivery technique, or the like. It should be appreciated that recipient device 120 and recipient device 125 may utilize the same or different message delivery techniques.

Subsequently, sending device 105 may initiate a refresh operation for message 205. Sending device 105 may send a refresh message 210-1. Sending device 105 sends refresh message 210-1 to messaging system 110. In one aspect, a user of sending device 105 may select message 205 within a sent message list and further select a refresh operation for implementation upon message 205. In another aspect, message 205 may be associated with an event such as a meeting or a call scheduled within an electronic calendar system. The electronic calendar system, e.g., executing in sending device 105, may be programmed to initiate the refresh operation automatically for message 205 at a predetermined time, or amount of time, prior to the scheduled event with which message 205 is associated.

In the example of FIG. 3, messaging system 110 may detect a refresh event by receiving refresh message 210-1. Responsive to receiving refresh message 210-1, messaging system 110 determines that refresh message 210-1 specifies a refresh operation to be initiated for message 205. Messaging system 110 may locate the master copy of message 205 stored therein. Further, messaging system 110 may identify the recipients and/or recipient devices of message 205.

As discussed, in another aspect, messaging system 110 may detect a refresh event internally as the expiration of a timer, the detection of a particular time, the detection of a time that is a particular amount of time prior to another event, etc. In that case, messaging system 110 need not receive refresh message 210-1 from sending device 105 to initiate the refresh operation for message 205.

In one embodiment, messaging system 110 may send refresh message 210-2 to recipient device 120. Refresh message 210-2, as sent to recipient device 120, may be a copy of refresh message 210-1, a reformatted or modified version of refresh message 210-1, or the like. In any case, refresh message 210-2, as provided to recipient device 120, may specify a refresh operation to be executed for message 205.

Recipient device 120, responsive to receiving refresh message 210-2, may identify a locally stored copy of message 205 stored therein, and display message 205 in a list of received messages using a refresh date and time stamp. The refresh date and time stamp, for purposes of a refresh message received in a recipient device, may be the date and time stamp of refresh message 210. For example, the refresh date and time stamp may be the date and time stamp of sending device 105 sending refresh message 210-1, the date and time stamp of messaging system 110 receiving refresh message 210-1, and/or the date and time stamp of messaging system 110 sending refresh message 210-2. This causes message 205-2, already stored locally within recipient device 120, to be displayed in an order as if only just received by recipient device 120, e.g., at or about the time of refresh message 210, instead of being displayed elsewhere, e.g., as if received several days, hours, and/or minutes ago. More particularly, message 205-2 may be displayed in an ordered list of messages according to the refresh date and time stamp instead of the original date and time stamp of message 205-2.

In another embodiment, messaging system 110 may send another copy of message 205 to recipient device 125 as message 205-4 responsive to receiving refresh message 210-1. As discussed, recipient device 125 may delete messages older than the age threshold and/or in accordance with an aggregate size threshold. Sending another copy of message 205, or resending message 205, to recipient device 125 ensures that information that may be needed by the user of recipient device 125 is stored locally through the resending of message 205 as message 205-4.

Message 205-4 may include the date and time stamp of message 205-3. Message 205-4 also may include a refresh date and time stamp. The refresh date, as applied to a second copy of a message, is the date and time stamp of messaging system 110 sending message 205-4 and/or the date and time stamp for refresh message 210. In this example, the date and time stamp of message 210 is the date and time stamp of sending device 105 sending refresh message 210-1 and/or the date and time stamp of messaging system 110 receiving refresh message 210-1. In this regard, message 205-4 may indicate the refresh date and time stamp in addition to the date and time stamp of when message 205 (i.e., message 205-3) was originally sent. The date and time stamp of message 205-3 may be referred to as the original time stamp. Recipient device 125 may interpret the date and time stamp information and use the refresh date and time stamp for purposes of locating message 205-4 in a list of messages sorted by date and time stamp.

The refresh operations described herein may cause messaging system 110 to send further copies of a prior sent message to one or more recipient devices. It should be appreciated, however, that sending device 105 need not send a further copy of message 205 to implement a refresh operation. Since the size of message 205 may be large, the inventive arrangements described within this disclosure help to reduce network traffic by eliminating the need for sending device 105 to resent message 205. In cases where refresh message 210-1 is sent, refresh message 210-1 may be significantly smaller in size than message 205-1. In other cases, as described above, sending device 105 need not send refresh message 210-1 to initiate a refresh operation.

In another embodiment, messaging system 110 may send refresh message 210-2 to recipient device 120 and also send message 205-4 to recipient device 125. The sending of refresh message 210-2 and message 205-4 may be performed concurrently or simultaneously. Similar message handling operations regarding message 205 may be performed with respect to devices of other recipients of message 205.

In another aspect, in sending a message, e.g., resending a message, to a recipient device in response to a refresh message, messaging system 110 need not create a further copy of the sent message. For example, referring to FIG. 3, messaging system 110 may send message 205-4 to recipient device 125 in response to receiving refresh message 210-1. Messaging system 110 may resend a copy of message 205 to recipient device 125 without creating another copy of message 205 that is stored. For example, messaging system 110 may store a single copy of message 205, i.e., the master copy of message 205. Instead of creating additional copies of a message when resending, messaging system 110 may annotate, or mark, the master copy of the message by noting that another copy of message 205 was sent. The annotation may include a date and time stamp for refresh message 210-1 and/or a date and time stamp for message 205-4. The annotation may include another identifier associated with the master copy of the message indicating that a refresh operation was performed for the message.

In another aspect, messaging system 110 may send message 205-4 to recipient device 125 only responsive to determining that the original copy of message 205, i.e., message 205-3, has been deleted and is no longer stored locally on recipient device 125. In still another aspect, messaging system 110 may send message 205-4 to recipient device 125 only responsive to identifying recipient device 125 as an enumerated type of device.

Messaging system 110 may determine whether recipient device 125 is an enumerated type of device using any of a variety of different techniques. In one aspect, for example, messaging system 110 may store a list of enumerated devices where the enumerated devices are associated with users and/or message addresses (e.g., email addresses). Messaging system 110 may identify a particular message to be refreshed from a received refresh message, determine whether a recipient of the message to be refreshed is on the list, and determine whether the user is associated with an enumerated device. If so, messaging system 110 may resend a copy of the previously sent message instead of sending a refresh message to the device.

In another aspect, recipient device 125 may send a communication to messaging system 110. The communication may be a request for newly received messages. Recipient device 125, for example, may be notified of the availability of new messages by messaging system 110 and, in response, request such messages (e.g., using a push message delivery technique). In another example, recipient device 125 may request newly received message periodically or from time to time (e.g., using a pull message delivery technique).

In any case, a communication from a device such as recipient device 125 may specify attributes such as the operating system executed by the device, a processor, a device type (mobile phone, mobile radio, tablet computer) or the like. In another example, the communication may include an identifier reserved for indicating whether the device is an enumerated device for purposes of message refresh. Messaging system 110 may store a list of device types, e.g., particular attributes, that, when detected in a communication from a device indicate that the device is an enumerated type of device. The attributes may be detected in a request for messages or in another communication from the device.

In response to a communication received from recipient device 125, message system 110 may determine whether to send a further copy of a previously sent message specified by a received refresh message or send the refresh message to recipient device 125 based upon one or more of the attributes detected within the of the communication from recipient device 125. For example, responsive to messaging system 110 identifying an enumerated device type (e.g., a mobile or phone device type), an enumerated operating system (e.g., a mobile operating system), an enumerated processor type, messaging system 110 may send message 205-4 to recipient device 125.

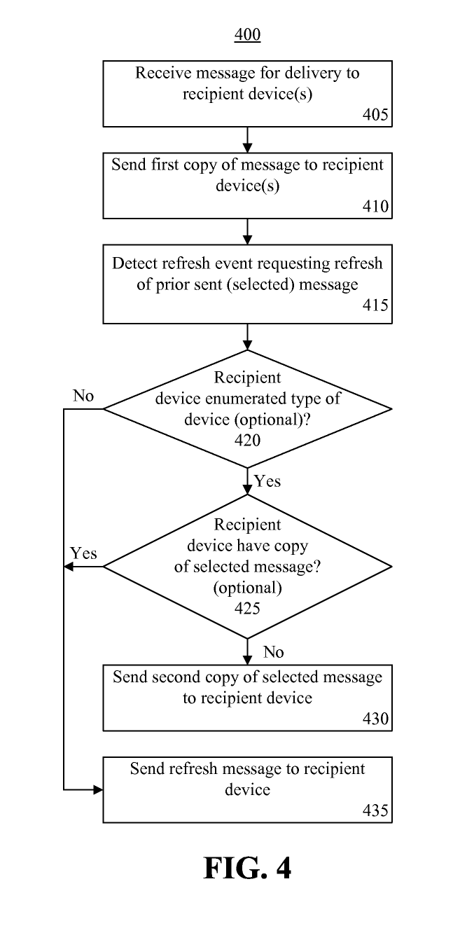

FIG. 4 is a flow chart illustrating another exemplary method 400 of message refresh. Method 400 may be performed by a messaging system having an architecture the same as or similar to that described with reference to FIG. 2. The messaging system may operate in a communication environment the same as or similar to that described with reference to FIG. 1.

In block 405, the messaging system may receive a message. The message may specify one or more different recipients. The message may be received from a device associated with a sender of the message, e.g., a sending device. In block 410, the messaging system may send the message, e.g., a first copy of the message, to one or more recipient devices. Recipient devices may be devices of the recipients of the message. In sending the first copy of the message to the recipient device(s), the messaging system may store or maintain a master copy of the message therein. The message system further may store the original date and time stamp in association with the master copy of the message.

In block 415, the messaging system may detect a refresh event. The refresh event may request the initiation of a refresh operation on the message, i.e., the previously sent message of block 410 also referred to as the “selected message.” In one embodiment, the detected refresh event may be the receipt of a refresh message. The refresh message may be received from a device associated with the sender of the selected message. In one aspect, the refresh message may be received from the same device that sent the selected message. In another aspect, the refresh message may be received from a different device than was used to send the selected message. The different device still is one that is associated with, or used by, the sender of the selected message.

In another embodiment, the detected refresh event may be the messaging server detecting the expiration of a timer, the occurrence of a date and/or time, the occurrence of a date and/or time prior to another, related event, etc. The timer, for example, may be set within the messaging system responsive to an instruction from the sending device that may or may not be included in the selected message. The particular date and/or time detected by the messaging server may be specified by an instruction included in the selected message.

In block 420, the messaging system optionally may determine whether the recipient device is an enumerated device type. An enumerated type of device may be one that requires sending, or resending, as the case may be, of a further copy of a previously sent message. An un-enumerated type of device may be one that does not require sending, or resending, a further copy of a previously sent message.

For example, in one embodiment, a recipient device may send a communication to the messaging system requesting new messages. The request for new messages may be initiated by the recipient device responsive to a new message notification sent from the messaging system or initiated by the recipient device without first being prompted by the messaging system. The request for new messages may specify one or more attributes of the recipient device as previously described within this disclosure. In addition, the request may specify credentials for the recipient such as messaging address, username, and/or password.

Responsive to determining that the recipient device is an enumerated type of device, method 400 may continue to block 425. Responsive to determining that the recipient device is not an enumerated type of device, method 400 may continue to block 435.

Continuing with block 424, the messaging system may optionally determine whether the recipient device has a local copy of the selected message. In one aspect, for example, the request for new messages may specify which messages are stored locally on the requesting device. In another aspect, the requesting device may send a separate communication indicating which messages are stored locally on the requesting device. In either case, the messaging system may determine whether the selected message for which the refresh event was detected is specified in the list of messages stored locally on the requesting device. If so, method 400 may continue to block 435. If not, method 400 may proceed to block 430.

In block 430, the messaging system may send a copy, e.g., a second copy, of the selected message to the recipient device. In sending the second copy, or resending the selected message as the case may be, the second copy may include the original date and time stamp of the first copy of the message as sent in block 410 and the refresh date and time stamp as previously described. The messaging system, for example, may modify the second copy of the selected message to include the refresh date and time stamp. The messaging system may also send an identifier as part of the second copy of the selected message that indicates that the second copy is a resent version of the previously sent selected message (i.e., a resent version of the first copy of the selected message).

In one aspect, the message system may mark the master copy of the selected message stored therein as “resent” or the subject of a refresh operation that has been performed. Further, the messaging system may associate the refresh date and time stamp with the master copy of the selected message as maintained in the messaging system. As such, the master copy of the selected message may be associated with both the original date and time stamp and the refresh date and time stamp.

The recipient device, responsive to receiving the second copy of the selected message, may display the second copy of the selected message in an order that is determined using the refresh date and time stamp as opposed to the date and time stamp of the first copy of the selected message.

In block 435, the messaging system may send a refresh message to the recipient device. The refresh message may be a copy of the refresh message received from the sending device, a modified version of the received refresh message, or the like. The recipient device, responsive to receiving the refresh message, may adjust the date and time stamp of the selected message stored locally within the recipient device to the refresh date and time stamp, thereby changing the location of the selected message within a list of messages in the recipient device sorted according to date and time stamp.

In one aspect, the message system may mark the master copy of the selected message stored therein as “resent” or the subject of a refresh operation that has been performed. Further, the messaging system may associate the refresh date and time stamp with the master copy of the message maintained in the messaging system. As such, the master copy of the selected message may be associated with the original date and time stamp and the refresh date and time stamp.

It should be appreciated that in another embodiment, the messaging system may maintain a record of master messages, a record of which messages were the subject of a refresh operation, the particular recipient devices to which refresh messages were sent, and/or the particular recipient devices to which additional copies of messages were sent as part of a refresh operation for the message. Date and time stamps for the operations described may also be stored as part of the records maintained in the message system.

In one aspect, the refresh message, as received by the recipient device, may specify an expiration date and time stamp. In another aspect, the recipient device may include processing rules indicating when a received refresh message is to expire. In either case, the recipient device may expire the refresh message in accordance with any expiration time limits and/or expiration date and time stamp specified. Responsive to the refresh message expiring, the date and time stamp of the selected message may be restored to the original date and time stamp, e.g., the date and time stamp for the first copy of the selected message to the recipient device. Any subsequent display of the selected message post expiration of the refresh message may be determined, e.g., within a list sorted according to date and time stamp, using the original date and time stamp of the first copy of the selected message instead of the date and time stamp of the refresh message.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “executable operation” or “operation” is a task performed by a data processing system or a processor within a data processing system unless the context indicates otherwise. Examples of executable operations include, but are not limited to, “processing,” “computing,” “calculating,” “determining,” “displaying,” “comparing,” or the like. In this regard, operations refer to actions and/or processes of the data processing system, e.g., a computer system, or similar electronic computing device, that manipulates and transforms data represented as physical (electronic) quantities within the computer system's registers and/or memories into other data similarly represented as physical quantities within the computer system memories and/or registers or other such information storage, transmission or display devices.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

The corresponding structures, materials, acts, and equivalents of all means or step plus function elements that may be found in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
sending, using a processor in a messaging system, a first copy of a message to a recipient device;
detecting, using the processor, a refresh event requesting a refresh operation for the message; and
responsive to the refresh message, sending, using the processor, a second copy of the message to the recipient device without creating a further copy of the message within the messaging system.

2. The method of claim 1, wherein the second copy of the message comprises an identifier indicating that the second copy of the message is a re-sent version of the first copy of the message.

3. The method of claim 3, wherein the second copy of the message specifies a date and time stamp of the first copy of the message and a refresh date and time stamp of the second copy of the message.

4. The method of claim 1, further comprising:
marking a copy of the message maintained in the messaging system as resent; and
associating a refresh date and time stamp of the second copy of the message with the copy of the message maintained in the messaging system.

5. The method of claim 1, wherein the message is an electronic mail message.

6. The method of claim 1, further comprising:
determining whether the recipient device includes a locally stored copy of the message;
wherein the second copy of the message is sent only responsive to determining that the recipient device does not include a locally stored copy of the message.

7. The method of claim 1, further comprising:
determining whether the recipient device is an enumerated type of device for receiving resent messages;
wherein the second copy of the message is only provided to the recipient device responsive to determining that the recipient device is an enumerated type of device.

8. A messaging system, comprising:
a processor programmed to initiate executable operations comprising:
sending a first copy of a message to a recipient device;
detecting a refresh event requesting a refresh operation for the message; and
responsive to the refresh event, sending a second copy of the message to the recipient device without creating a further copy of the message within the messaging system.

9. The messaging system of claim 8, wherein the second copy of the message comprises a refresh identifier indicating that the second copy of the message is a re-sent version of the first copy of the message.

10. The messaging system of claim 8, wherein the second copy of the message specifies a date and time stamp of the first copy of the message and a refresh date and time stamp of the second copy of the message.

11. The messaging system of claim 8, wherein the processor is further programmed to initiate executable operations comprising:
marking a copy of the message maintained in the messaging system as resent; and
associating a refresh date and time stamp of the second copy of the message with the copy of the message maintained in the messaging system.

12. The messaging system of claim 8, wherein the message is an electronic mail message.

13. The messaging system of claim 8, wherein the processor is further programmed to initiate executable operations comprising:
determining whether the recipient device includes a locally stored copy of the message;
wherein the second copy of the message is sent only responsive to determining that the recipient device does not include a locally stored copy of the message.

14. The messaging system of claim 8, wherein the processor is further programmed to initiate executable operations comprising:
determining whether the recipient device is an enumerated type of device for receiving resent messages;
wherein the second copy of the message is only provided to the recipient device responsive to determining that the recipient device is an enumerated type of device.

15. A computer program product comprising a computer readable storage medium having program code stored thereon, the program code executable by a processor to perform a method comprising:
sending, using the processor, a first copy of a message to a recipient device;
detecting, using the processor, a refresh event requesting a refresh operation for the message; and
responsive to the refresh event, sending, using the processor, a second copy of the message to the recipient device without creating a further copy of the message within the messaging system.

16. The computer program product of claim 15, wherein the second copy of the message comprises a refresh identifier indicating that the second copy of the message is a re-sent version of the first copy of the message.

17. The computer program product of claim 15, wherein the second copy of the message specifies a date and time stamp of the first copy of the message and a refresh date and time stamp of the second copy of the message.

18. The computer program product of claim 15, further comprising:
marking the copy of the message maintained in the messaging system as resent; and
associating a refresh date and time stamp of the second copy of the message with the copy of the message maintained in the messaging system.

19. The computer program product of claim 15, further comprising:
determining whether the recipient device is an enumerated type of device for receiving resent messages;
wherein the second copy of the message is only provided to the recipient device responsive to determining that the recipient device is an enumerated type of device.

20. The computer program product of claim 15, further comprising:
differentiating between the recipient mobile device and a different messaging system associated with the recipient, wherein the second copy of the message is only provided to the recipient mobile device.
